(19) United States
(12) Patent Application Publication
(10) Pub. No.: US 2014/0058872 A1
(43) Pub. Date: Feb. 27, 2014

(54) AUTOMATED BUNDLING AND PRICING BASED ON PURCHASE DATA

(71) Applicant: Carnegie Mellon University, Pittsburgh, PA (US)

(72) Inventors: Tuomas Sandholm, Pittsburgh, PA (US); Michael Benisch, Pittsburgh, PA (US)

(73) Assignee: Carnegie Mellon University, Pittsburgh, PA (US)

(21) Appl. No.: 13/973,670

(22) Filed: Aug. 22, 2013

Related U.S. Application Data
(60) Provisional application No. 61/742,944, filed on Aug. 22, 2012.

(51) Int. Cl. G06Q 30/06

(52) U.S. Cl. CPC G06Q 30/0601
USPC 705/26.1

(57) ABSTRACT

A computer-implemented method includes, in one aspect, accessing historical purchase data that is indicative of items that have been purchased and prices at which each of the items are purchased; for each of the items specified in the historical purchase data, fitting a customer valuation model to a portion of the historical purchase data that pertains to the item, with the customer valuation model specifying purchase preferences, and with a purchase preference specifying a probability a customer will purchase a specific item at a specific price; based on fitted customer valuation models for the items in the historical purchase data, identifying a priceable bundle, with the priceable bundle including at least two of the items specified in the historical purchase data; and applying updated prices to one or more of (i) the priceable bundle, and (ii) the items included in the priceable bundle.

### CROSS-REFERENCE TO RELATED APPLICATION

This application claims the benefit of priority under 35 U.S.C. §119(e) to provisional U.S. Patent Application No. 61/742,944, filed on Aug. 22, 2012, the entire contents of which are hereby incorporated by reference.

### STATEMENT REGARDING FEDERALLY SPONSORED RESEARCH AND DEVELOPMENT

This invention was made with partial government support under National Science Foundation grant number IIS-0964579. The government has certain rights in the invention.

### FIELD OF USE

The present disclosure relates to bundling and pricing based on purchase data.

### BACKGROUND

Business-to-customer (B2C) retail sales account for nearly four trillion dollars in the United States annually, and the percentage of this shopping done online increased three-fold between 2002 and 2007. Yet, despite the increased computational power, connectivity, and data available today, most online and brick-and-mortar retail mechanisms remain nearly identical to their centuries-old original form: item-only catalog pricing (e.g., take-it-or-leave-it offers). These may be the default of B2C trade and are typically used by massive online retailers. However, they are fundamentally inexpressive because they typically do not allow sellers to offer discounts on different combinations, or bundles, of items.

Recently, some electronic retailers have started offering large numbers of bundle discounts (e.g., motherboards and memory at computer hardware sites, and songs or albums on music sites), and brick-and-mortar retailers may offer bundle discounts on select items, such as food and drinks. Such discounts may make the item-only catalog more expressive, and can be viewed as part of the general trend toward increased expressiveness in economic mechanisms. Increases in expressiveness may yield better outcomes in the design of general economic mechanisms, and in a number of specific domains such as sourcing auctions, advertisement markets, and privacy mechanisms.

Researchers in economics, operations research, and computer science have studied issues surrounding choosing prices and bundles in various types of catalog settings for decades. However, this work has either been i) largely theoretical in nature rather than operational, ii) focused on specific types of customer survey data which is not available in many applications, or iii) focused on specific sub-problems (e.g., pricing information goods, item-only pricing, or unit-demand and single-minded customers). Despite the ability to collect substantial amounts of data about actual customer responses to different pricing schemes, retailers in most domains may still be lacking practical techniques to help them identify promising bundle discounts to offer.

### SUMMARY

The present disclosure describes methods and systems relating to automatically suggesting bundles of products, services, or both to offer as a combined sale, profit-maximizing prices for such bundles, and pricing discounts for such bundles, based on historical purchase data. A pricing algorithm may be used to compute high-profit prices, and a fitting algorithm may be used to estimate a customer valuation model. As new purchase data is collected, the purchase data may be integrated into the model fitting process to continually refine prices and discounts.

In one aspect of the present disclosure, a computer-implemented method comprises accessing historical purchase data that is indicative of items that have been purchased and prices at which each of the items are purchased; for each of the items specified in the historical purchase data, fitting a customer valuation model to a portion of the historical purchase data that pertains to the item, with the customer valuation model specifying purchase preferences, and with a purchase preference specifying a probability a customer will purchase a specific item at a specific price; based on fitted customer valuation models for the items in the historical purchase data, identifying a priceable bundle, with the priceable bundle including at least two of the items specified in the historical purchase data; applying updated prices to one or more of (i) the priceable bundle, and (ii) the items included in the priceable bundle.

Implementations of the disclosure can include one or more of the following features. The updated prices optimize a value or cause the value to exceed a threshold level, with the value comprising one or more of: a profit of a seller providing a bundle; an amount of sales for the bundle; an amount of revenue for the bundle; a customer's surplus for the bundle, wherein the customer's surplus corresponds to a valuation of the bundle minus a price paid for the bundle by the customer; and an amount of efficiency for the bundle, wherein the efficiency corresponds to the customer's surplus combined with the profit of the seller. The customer valuation model comprises a plurality of parameters, and wherein at least one of the parameters comprises a mean valuation of the specific item, a variance for a valuation of the specific item, and covariances between valuations for specific items. The computer-implemented method may further comprise: determining a valuation of the priceable bundle by combining fitted customer valuation models of the items included in the priceable bundle. Fitting the customer valuation model comprises: generating a graph the includes one or more edges and a plurality of nodes, where each node of the plurality of nodes is associated with an item specified in the historical purchase data, and each edge of the one or more edges is associated with a variable representing a bonus or a penalty for a bundle including items associated with nodes connected by the edge; performing a tree search of the graph over variances and covariances associated with bundles included in the graph; performing a pivot-based search at each leaf node of the plurality of nodes over mean valuations associated with the bundles included in the graph; and selecting a mean valuation, a variance, and a covariance that correspond to the historical purchase data. Identifying the priceable bundle comprises: identifying, based on application of a pricing algorithm, the priceable bundle. The pricing algorithm comprises one or more of an exhaustive pricing algorithm, a hill-climbing pricing algorithm, a gradient-ascent pricing algorithm, and a pivot-based pricing algorithm.

In another aspect of the present disclosure, a computer-implemented method comprises accessing historical purchase data that is indicative of items of a bundle that have been purchased and prices at which each of the items are purchased; determining mean values and variance values for valuations of the items and covariance values between valuations of the items; generating, by one or more processing devices, a graph the includes one or more edges and a plurality of nodes, where each node of the plurality of nodes is associated with an item, and each edge of the one or more edges is associated with a variable representing a bonus or a penalty for a set including items associated with nodes connected by the edge; performing a tree search of the graph over variances and covariances associated with sets included in the graph; performing a pivot-based search at each leaf node of the plurality of nodes over means associated with the sets included in the graph; selecting one or more mean values, one or more variance values, and one or more covariance values that correspond to the historical purchase data; and fitting, to the historical purchase data, a customer valuation model for one or more of (i) the bundle, and (ii) items in the bundle, with the customer valuation model being in accordance with the selected one or more mean values, the one or more variance values, and the one or more covariance values.

In yet another aspect of the present disclosure, a computer-implemented method comprises accessing a customer valuation model for purchase preferences of a plurality of items, and with a purchase preference specifying a probability a customer will purchase a specific item at a specific price; based on the customer valuation model for the plurality of items, identifying a one or more of a priceable bundle and prices for items in the priceable bundle, with the priceable bundle including at least two of the items in the plurality; and applying updated prices to one or more of (i) the priceable bundle, and (ii) the items included in the priceable bundle.

In yet another aspect of the present disclosure, a computer-implemented method comprises accessing a customer valuation model, with the customer valuation model specifying initial purchase preferences of items, and with an initial purchase preference specifying a probability a customer will purchase an item at an initial price; accessing updated historical purchase data that is indicative of updated prices at which each of the items are purchased; for each of the items specified in the updated historical purchase data, updating the customer valuation model to fit the updated historical purchase data; and based on the updated customer valuation model, identifying a priceable bundle, with the priceable bundle including at least two of the items specified in the updated historical purchase data.

Implementations of the disclosure can include one or more of the following features. The operations further comprise repeating the actions of the method at one or more of periodic time intervals, predefined time intervals and requested time intervals. The operations further comprise repeating the actions of the method upon detection of a triggering event. The triggering event comprises one or more of (i) a specified amount of purchases of one or more items in the priceable bundle having occurred, and (ii) a specified amount of purchases of one or more items in the priceable bundle having occurred in a category.

All or part of the foregoing may be implemented as a computer program product including instructions that are stored on one or more non-transitory machine-readable storage media, and that are executable on one or more processing devices. All or part of the foregoing may be implemented as an apparatus, method, or electronic system that may include one or more processing devices and memory to store executable instructions to implement the stated functions.

The details of one or more implementations are set forth in the accompanying drawings and the description below. Other features, objects, and advantages will be apparent from the description, the drawings, and the claims.

### BRIEF DESCRIPTION OF THE FIGURES

FIG. 1 is a block diagram of an example of a network environment for bundling and pricing products, services, or both.

FIG. 2 is a block diagram of examples of components of the network environment of FIG. 1.

FIG. 3 is a flowchart of an example of a process for bundling and pricing products, services, or both based on historical purchase data.

FIG. 4 shows an example of a hyper-graph depicting a customer valuation model and examples of probability distribution functions for a bundle and individual items included in the bundle.

### DETAILED DESCRIPTION

The present disclosure describes methods and systems related to bundling and pricing products, services, or both based on purchase data and economic factors. Purchase data may be automatically mined and profit-maximizing prices, bundles, and discounts may be suggested. A fitting algorithm may be used to estimate a customer valuation model, and pricing algorithms may be used to compute high-profit prices on items and bundles. In addition to means, variances, and covariances on items, means and variances on complementarity (substitutability) may be captured. New purchase data can be integrated into the model fitting in an online process that continually refines prices and bundle discounts.

Various implementations of the present disclosure are discussed below in the context of a seller with m different kinds of items who wishes to choose a set of prices to offer on different combinations of those items to one customer at a time. For settings where the seller has a very large value of m (e.g., supermarkets or large online retailers, which can have hundreds of thousands or millions of different items), the analysis can be performed independently on significantly smaller subsets of the seller's full offering, assuming customers make decisions about the subsets independently. The framework may be generalized to consider settings with more than one customer by measuring expectations for profit and revenue, which implies that item prices may not depend on the identity of the customer. In some cases, a seller can offer discounts on bundles and may hold the item prices fixed for some exogenous reason (e.g., due to existing policies or competition). The seller may have a cost function that can be approximated by assigning each item a fixed cost per unit sold (e.g., in the case of digital goods, which have no marginal cost to produce, the seller may estimate some form of amortized cost), and the seller's goal may be to maximize expected profit (revenue minus cost).

The customer has a valuation, v(x), for each bundle x, and chooses to purchase the bundle that maximizes her surplus (valuation minus price). The assumption of free disposal (e.g., the value of a bundle is at least as much as the value of any sub-bundle) may be used. In some implementations, the complexity of the valuations may be restricted to ensure tractability for larger values of m, with a valuation for each bundle that may be drawn from a probability distribution. Expected values of revenue, seller's profit, surplus, and efficiency (buyer's surplus plus seller's profit) may be measured.

For any catalog pricing setting with at least two items, a and b, a seller may not semi-shatter the two pairs of outcomes where a customer buys {{a}, {b}} and {{a, b}, } using an item-only price catalog. A mapping from each of the theoretical entities in the catalog pricing setting to an equivalent entity may be constructed. Under the mapping, the seller's type, which is unknown to the customer, may determine the seller's cost function. The customer's type, which is unknown to the seller, determines the customer's valuation for every combination of items. For a fully expressive catalog, the seller's expression space includes every possible offering of prices on every combination of items. For an item-only catalog, the seller's expression space consists of offerings on individual items only. The customer's expression space may be the same as the customer's type space, rather than having the expression space be simply a choice of bundle, and that, given that type, the outcome function chooses the outcome corresponding to a surplus maximizing bundle for the customer. Such mapping may ensure that the outcome function is sensitive to the expressions of both the customer and the seller. The surplus-maximization process may be encoded in the outcome function.

An alternative mapping may be mapping the customer's expressions directly to bundle choices. However, holding the customer's expression fixed and drastically changing the seller's prices may not change the outcome chosen. Thus, an item-only catalog may be inefficient for some cost functions and valuation distributions, even if the customer and the seller are trying to maximize efficiency. Typically, in catalog settings, the seller may offer more expressive catalogs only if that results in greater expected profit and may choose prices that maximize profit rather than efficiency. Using the computational methodology described in this disclosure, the scenarios when it is in a seller's best interest to use a more expressive price catalog may be determined.

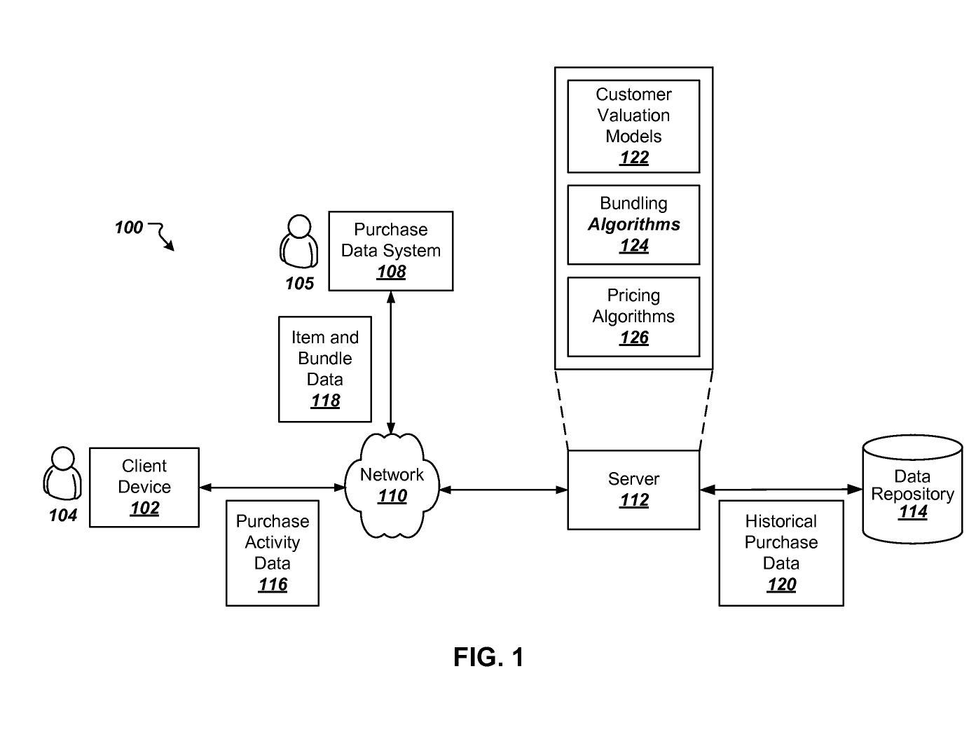

FIG. 1 is a block diagram of an example of a network environment 100 for bundling and pricing products, services, or both based on purchase data and economic factors. Network environment 100 includes client device 102, a purchase data system 108, network 110, server 112, and data repository 114.

The client device 102 is used by a user 104, such as a customer. The user 104 may use the client device 102 to make purchases from an online retail mechanism. The client device 102 sends purchase activity data 116 to the server 112. The server 112 may store the purchase activity data 116 in a data repository 114.

The purchase data system 108 is used by user 105, such as a seller of a product or a provider of a service. The purchases data system 108 may receive item and bundle data 118. The item and bundle data 118 may include information indicative of, for example, prices of items, suggested bundles, and prices of suggested bundles. The purchase data system 108 may present the item and bundle data 118 to the user 105 on a display device of the purchase data system 108.

The server 112 is a system for bundling and pricing products, services, or both based on purchase data and economic factors. The server 112 may retrieve historical purchase data 120 from the data repository 114. The historical purchase data 120 may include information indicative of items that have been purchased and prices at which each of the items was purchased. The server 112 may bundle and price products, services, or both using the historical purchase data 120, customer valuation models 122, bundling algorithms 124, and pricing algorithms 126.

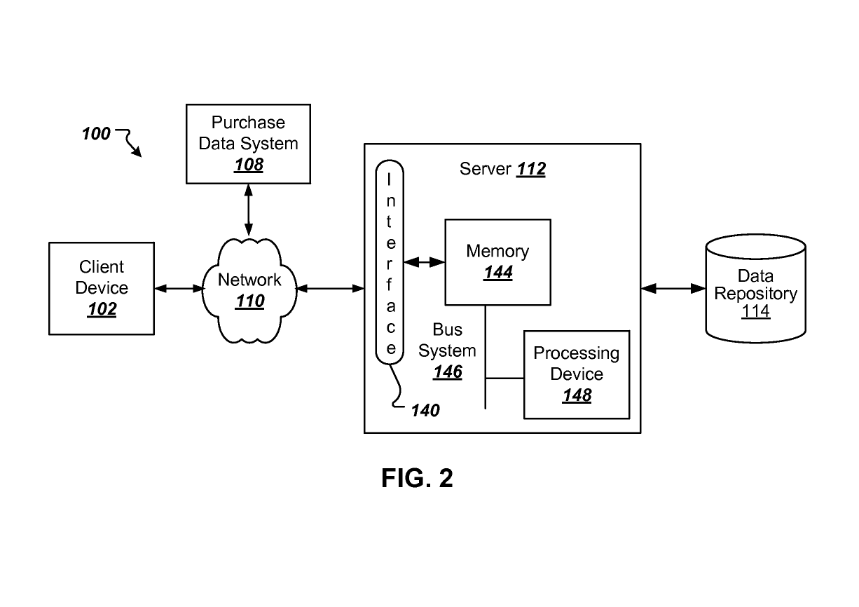

FIG. 2 is a block diagram of examples of components of the network environment 100 of FIG. 1. In FIG. 2, the client device 102 and the purchase data system 108 can be any sort of computing devices capable of taking input from a user and communicating over network 110 with server 112 and/or with other client devices. For example, the client device 102 and the purchase data system 108 can be mobile devices, desktop computers, laptops, cell phones, personal digital assistants (“PDAs”), servers, embedded computing systems, and so forth.

Server 112 can be any of a variety of computing devices capable of receiving data, such as a server, a distributed computing system, a desktop computer, a laptop, a cell phone, a rack-mounted server, and so forth. Server 112 may be a single server or a group of servers that are at a same location or at different locations.

The illustrated server 112 can receive data from the client device 102 and the purchase data system 108 via input/output (“I/O”) interface 140. I/O interface 140 can be any type of interface capable of receiving data over a network, such as an Ethernet interface, a wireless networking interface, a fiber-optic networking interface, a modem, and so forth. Server 112 also includes a processing device 148 and memory 144. A bus system 146, including, for example, a data bus and a motherboard, can be used to establish and to control data communication between the components of server 112.

The illustrated processing device 148 may include one or more microprocessors. Generally, processing device 148 may include any appropriate processor and/or logic that is capable of receiving and storing data, and of communicating over a network (not shown). Memory 144 can include a hard drive and a random access memory storage device, such as a dynamic random access memory, or other types of non-transitory machine-readable storage devices. Memory 144 stores computer programs (not shown) that are executable by processing device 148 to perform the techniques described herein.

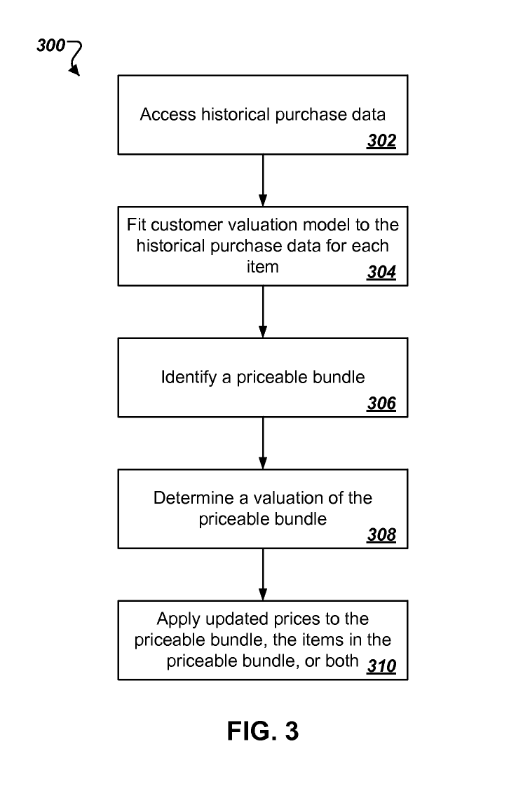

FIG. 3 is a flowchart of an example of a process 300 for bundling and pricing products, services, or both based on historical purchase data. The process 300 may be performed by a system of one or more computers, such as server 122 of FIGS. 1 and 2.

The process 300 includes accessing historical purchase data (302). The historical purchase data may be indicative of items that have been purchased and prices at which each of the items was purchased.

For each of the items specified in the historical purchase data, a customer valuation model may be fitted to a portion of the historical purchase data that pertains to the item (304). The customer valuation model may specify purchase preferences. A purchase preference may specify the probability a customer will purchase a specific item at a specific price. For any given bundle, x, and price catalog, π, the system may estimate P(x|π), the probability that the customer will buy x. The domain of P(x|π) may be exponential in the number of items and P(x|π) can be fairly complex. The estimated probability function, P, may be a probability distribution (e.g., the purchase probabilities of all bundles, including the empty bundle, sum to one for every possible catalog).

Customer valuation modeling may involve predictions about what would happen to the purchase frequencies under different price catalogs. Customer valuation modeling considers the price catalogs that were on offer at the time of purchase, which can provide additional information about sensitivities to price changes. For valuation modeling, a set of historical purchase observations, D={<x₁, π₁, >, <x₂, π₂>, . . . , <xₙ, πₙ>} may be used, where each observation, i, includes a bundle that was purchased, xᵢ, by a distinct customer, i, and the prices of all bundles at the time, πₜᵢ. In the case of item-only pricing, a bundle's price is the sum of the prices of the items it contains. Some of the observations may have the same π. In valuation modeling, it may be assumed that purchases were made based on each customer's surplus-maximizing behavior with valuations drawn from an underlying valuation model. It may also be assume that each purchase is independent of all others since each observation may be considered to be from a distinct customer. Under these assumptions, the maximum likelihood estimate (e.g., a model that maximizes the likelihood of the data) for the customer valuations may yield a \hat{P} that matches the observed purchase frequencies as closely as possible.

Deriving the maximum likelihood estimate for \hat{P} may involve predicting the frequencies observed in the data for each catalog. For shorthand, \hat{P}(B=xᵢ|πⱼ) may be denoted as \hat{P}ᵢⱼ. The log likelihood of the data given \hat{P}, l(D|\hat{P}), is then given by the following.

$${\hat{P}}_{ij} = \hat{P} ( B = {x}_{i} \vert {π}_{j} )$$

$$L ( D \vert \hat{P} ) = {\prod }_{i}^{ } {\hat{P}}_{ii}$$

$$𝓁 ( D \vert \hat{P} ) = {\sum }_{i}^{ } log ( {\hat{P}}_{ii} )$$

For short, the number of observations containing catalog j may be denoted as Dⱼ, and the number of observations containing bundle i and catalog j may be denoted as Dᵢⱼ. l(D|P) can be rewritten by aggregating over catalogs and bundles instead of data points, as indicated by the following.

$$𝓁 ( D \vert \hat{P} ) = {\sum }_{j}^{ } [ {\sum }_{b ∈ B}^{ } {D}_{bj} log ( {\hat{P}}_{bj} ) + ( {D}_{j} - {\sum }_{{b}^{′}}^{ } {D}_{{b}^{′} j} ) log ( 1 - {\sum }_{{b}^{′}}^{ } {\hat{P}}_{{b}^{′} j} ) ]$$

The partial derivative of l with respect to a given value of \hat{P}, set it equal to zero, is solved for the point where the data likelihood is not changing. Setting the partial derivative to zero and solving for a maximum shows the following.

$$\frac{{D}_{ij}}{{\hat{P}}_{ij}^{*}} - \frac{{D}_{j} - {\sum }_{{i}^{′}}^{ } {D}_{{i}^{′} j}}{1 - {\sum }_{{i}^{′}}^{ } {\hat{P}}_{{i}^{′} j}^{*}} = 0$$

$$\frac{\partial 𝓁}{\partial {\hat{P}}_{ij}} = \frac{{D}_{ij}}{{\hat{P}}_{ij}} - \frac{{D}_{j} - {\sum }_{{i}^{′}}^{ } {D}_{{i}^{′} j}}{1 - {\sum }_{{i}^{′}}^{ } {\hat{P}}_{{i}^{′} j}}$$

$$0 = \frac{{D}_{ij}}{{\hat{P}}_{ij}^{*}} - \frac{{D}_{j} - {\sum }_{{i}^{′}}^{ } {D}_{{i}^{′} j}}{1 - {\sum }_{{i}^{′}}^{ } {\hat{P}}_{{i}^{′} j}^{*}}$$

$$\frac{{D}_{ij}}{{\hat{P}}_{ij}^{*}} = \frac{{D}_{j} - {\sum }_{{i}^{′}}^{ } {D}_{{i}^{′} j}}{1 - {\sum }_{{i}^{′}}^{ } {\hat{P}}_{{i}^{′} j}^{*}}$$

$${D}_{ij} ( 1 - {\sum }_{{i}^{′}}^{ } {\hat{P}}_{{i}^{′} j}^{*} ) = {\hat{P}}_{ij}^{*} {D}_{j} ( 1 - {\sum }_{{i}^{′}}^{ } \frac{{D}_{{i}^{′} j}}{{D}_{j}} )$$

$$\frac{{D}_{ij}}{{D}_{j} } ( 1 - {\sum }_{{i}^{′}}^{ } {\hat{P}}_{{i}^{′} j}^{*} ) = {\hat{P}}_{ij}^{*} ( 1 - {\sum }_{{i}^{′}}^{ } \frac{{D}_{{i}^{′} j}}{{D}_{j}} )$$

If all the bundle probabilities other than i are assumed to be equal to the percentage of the data in which they appear under each catalog

$$( e . g . , ∀ {i}^{′} \neq i , {\hat{P}}_{{i}^{′} j}^{*} = \frac{{D}_{{i}^{′} j}}{{D}_{j}} ) , \\ then$$

$$\frac{{D}_{ij}}{{D}_{j}}$$

is the unique solution for \hat{P}ᵢⱼ*. Thus, any model that is used for estimating customer valuations may predict the purchase frequencies observed in the data as closely as possible.

The valuation model may allow for normally distributed valuations on each item, pair-wise covariance between valuations for items, as well as normally distributed terms for complementarity (or substitutability in case such a term is negative). This model may allow for heterogeneous complementarity and substitutability between products.

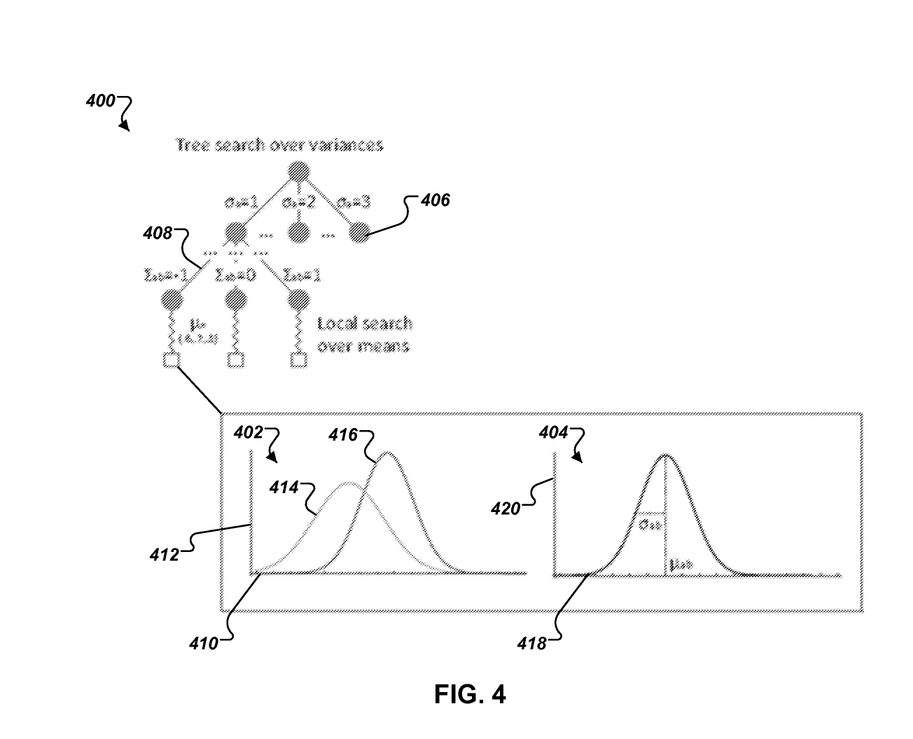

The model parameters may include a mean and variance for the valuation of each priceable bundle in \hat{B} and covariances between individual items' valuations. While the draw, y_{[i]}, from the distribution of an item i represents that item's valuation, v({i}), to the customer, a draw from the distribution for a bundle x of two or more items represents a complementarity bonus (or substitutability penalty if negative). The valuation for a bundle is then the sum of the draws of all the bundles (including individual items) it contains: v(x)=Σ_{x′} [symbol] ₓy_{x′}. Under this model, a customer's valuation can be considered a hyper-graph. FIG. 4 shows an example of a hyper-graph 400. The hyper-graph 400 includes nodes 406 and (hyper-)edges 408. Each node 406 may be associated with an item. Each (hyper-)edge 408 may be associated with a real-valued random variable representing the valuation bonus or penalty for receiving a bundle containing the items connected by the (hyper-)edge. Possible distribution over valuations (without loss of generality) may be modeled. For example, consider a setting with three items where a customer receives a complementarity bonus from any single pair but no additional bonus for more than one pair. Here, complementarity edges between all pairs and a substitutability three-edge connecting all three items may be used to avoid double counting.

To go from a valuation model to the probability function, P, a Monte-Carlo method may be used to sample customers (e.g., 10,000 customers) according to the valuation distribution. For a given catalog, their surplus-maximizing purchasing behavior (taking into account that disposal is free) may be simulated. In the simulation, items that are not connected by a complementarity or substitutability edge can be considered independently.

FIG. 4 includes graphs 402 and 404 showing examples of probability distribution functions (PDFs) for two items, a and b. For graph 402, the axis 410 represents a price distribution for items a and b, and the axis 412 represents a probability that a customer would be willing to pay the price indicated by the axis 410 for the items a and b. Curve 414 depicts the PDF for item a, and curve 416 depicts the PDF for item b. For graph 404, the axis 418 represents a price distribution for a bundle that includes items a and b, and the axis 420 represents a probability that a customer would be willing to pay the price indicated by the axis 418 for the bundle. Curve 422 depicts the PDF for the bundle.

In order to identify the model parameters that maximize the likelihood of the observed data, a hybrid search technique that combines tree search and pivot-based search may be used on the hyper-graph 400. It begins by performing a tree search over the variance and covariance parameters. A range for each of these parameters is given as input that is discretized into a specified number of values (in our experiments we use six values per parameter). A tree search is then performed that considers every possible assignment of variances. At each leaf node, a local search is performed to find the means that maximize the data likelihood given the values of the variance parameters at that leaf. The local search may be a pivot-based search. Leaf nodes are evaluated based on how closely the corresponding model predicts the observed historical purchase data. For example, the leaf nodes may be evaluated based on how closely the model's optimal profit matches the profit achieved by existing prices. The parameter settings resulting in the highest overall likelihood may be returned. In the case of a tie, an even mixture of all the tied models is used (e.g., simulated customers are sampled from each with equal probability). The parameter settings may include a mean valuation, a variance, and a covariance that correspond to the historical purchase data.

The technique of first choosing standard deviations using tree search and finding means using local search may provide better results than exclusively using tree search or local search for all parameters. This may be due to the tight relationship between the appropriate means and standard deviations. Once the standard deviations have been fixed, the best means may be identified using local search. However, the best means may change with a relatively small change in standard deviations. Using tree search exclusively may also produce good results, but the complexity of such a search may make it infeasible to conduct on fine-grained parameter values.

Historical purchase data may involve only a single catalog. They may not include information about customers' surplus-maximizing behavior under alternative prices, and, thus, may be under-specified for the purposes of inferring a valuation model. In these situations, the existing item prices may be used as an additional piece of information to fit the customer valuation model. Among models that approximately fit the observed purchase data, models whose profit under the optimal item-pricing for that model is close to the profit of the existing item prices under the model may be preferred. In some implementations, an item-price vector comparison may be used as an alternative to the profit-based comparison. The profit-based comparison, however, may be better at measuring the quality of the original pricing and may be more stable than the item-price vector comparison. The customer valuation algorithm does this test once at every leaf of the search tree (after the best model for the leaf has been computed as described above). If there are several leaves that are (approximately) as good at explaining the purchase data and the existing prices, an even mixture over those models may be used. For example, the top five models, or fewer if less than five meet the threshold for “approximately as good”, may be used.

Based on the fitted customer valuation models for the items in the historical purchase data, a priceable bundle that includes at least two of the items specified in the historical purchase data based on fitted customer valuation models for the items in the historical purchase data may be identified (306). The priceable bundle includes at least two of the items specified in the historical purchase data. The priceable bundle may be identified based on a bundling algorithm. The bundling algorithm may include searching over all possible bundles, searching over bundles that include less than a specified number of items, searching over bundles with items that are unrelated to any other items, or a combination of searches. Unrelated items may be defined by a seller or inferred from the historical purchase data about the co-occurrence of purchases of items.

For example, two items may be considered as related if their joint purchase frequency is more than a fixed threshold different (e.g., 1% different) than the product of their individual purchase frequencies. A graph may be constructed where the items are nodes and edges connect items that are related. Based on the graph, connected components of size two and pairs of isolated items may be included in a priceable bundle. The profit and surplus increases for each priceable bundle and a set of similar results on asymmetric instances may be estimated. The increase for a given bundle may be estimated as, for example, the average value for the five most similar instances (based on the frequencies of the two items and the bundle). Priceable bundles may be selected to be discounted based on their predicted profit increase. Once a bundle is selected, all other bundles containing either of the selected items may be removed from consideration.

A valuation of the priceable bundle may be determined (308). A valuation of the priceable bundle may be determined by, for example, combining fitted customer valuation models of the individual items included in the priceable bundle.

Updated prices may be applied to the priceable bundle, the items included in the priceable bundle, or both (310). Relative to information indicated by the historical purchase data, the updated prices may increase (e.g., optimized), for example, the profit of the seller, the quantity of the bundle sold, the revenue of the seller, the customer's surplus, the amount of efficiency, or a combination of these values.

Updated prices may be applied to the priceable bundle using pricing algorithms. The pricing algorithms may determine the seller's profit-maximizing prices for a given type of catalog, cost function, and distribution over customer valuations. These algorithms may enable the measurement of the expected profit, efficiency, and surplus of different catalog mechanisms for various settings, and allow identification of characteristics of valuation distributions where the economy may be hurt by item-price-only catalogs.

The pricing algorithms may be based on a probability distribution over outcomes for a given price catalog (e.g., purchase preferences). Each algorithm may receive as input an estimate of the probability function, \hat{P}, the seller's cost function, c(x), a set of priceable bundles, \hat{B} (determined by the type of catalog), lower and upper bounds on the price of each bundle, L(x) and U(x) (also determined by the type of catalog, and can be used to ensure certain prices are fixed), and a seed price catalog, π⁽⁰⁾ (which need not be intelligently generated). The algorithms can choose any arbitrary prices for the different bundles as long as the price of a bundle is no greater than the sum of any collection of sub-bundles that contain all of its items. This may ensure that the catalog is consistent so that a customer cannot get a better price on a bundle by purchasing its components in some other combinations. This is similar to the free disposal assumption for customer valuations discussed earlier but applied to the seller's catalog. The algorithms each call \hat{P} repeatedly with different candidate catalogs in order to try to identify the one with the highest expected profit: max_{π}Σ_{bεB}\hat{P}(x|π)×(π(x)−c(x)).

An example of a pricing algorithm is exhaustive pricing (EX). For each priceable bundle, \hat{x}ε\hat{B}, this algorithm discretizes the space between L(\hat{x}) and U(\hat{x}) into k evenly-spaced prices and checks the expected profit of every possible mapping of prices to priceable bundles. It may find an optimal solution (subject to discretization), but may be intractable with more than two items and even with two items if k is too large. For a fully expressive catalog (e.g., one where each bundle is priced separately) with m items, this algorithm calls \hat{P} with k²^{^{m}}⁻¹ different catalogs, and \hat{P} may be costly to compute. Thus, this algorithm may be used as a tool to compare results with results of other algorithms on small instances.

Another example of a pricing algorithm is hill-climbing pricing (HC). Starting with the seed catalog, this algorithm computes the improvement in expected profit achieved by adding or subtracting a fixed Δ from each priceable bundle, which involves 2|\hat{B}| calls to \hat{P}, in each step. It updates the catalog with the change that leads to the greatest improvement, and repeats this process until there are no more improving changes. The resulting catalog is returned, and, since the catalog is only updated when an improvement is possible, it may have the highest observed expected profit.

Another example of a pricing algorithm is gradient-ascent pricing (GA). Starting with the seed catalog, this algorithm computes the gradient, or partial derivative, of the expected profit function, which involves |\hat{B}| calls to \hat{P} in each step. The partial derivative, \vec{d}(x), of the expected profit function with respect to a bundle, x, is estimated by measuring the change in expected profit when a fixed Δ is added to π(x). The resulting vector of derivatives, \vec{d}, is normalized to sum to one, and the algorithm updates its best candidate catalog by adding \vec{d}(x)×Δ to the price of each priceable bundle. The algorithm may continue this process until no more improvements in expected profit are possible. The resulting catalog is returned, and, as with the hill-climbing algorithm, it may be the one with the highest expected revenue that was explored throughout the search.

Another example of a pricing algorithm is pivot-based pricing (PVT). This algorithm generalizes hill-climbing by searching for the best adjustment to the current prices of up to k bundles at a time. For each k-or-less-sized combination of priceable bundles, β, this algorithm measures the change in expected profit from simultaneously adjusting all the prices in β. Each price can be incremented by Δ, decremented by Δ, or not changed. At each step, the algorithm tests all of those possibilities and may select the one the highest increase in expected profit. The hill-climbing algorithm above is a special case of this algorithm where k=1. However, for larger values of k, PVT generalizes the hill-climbing algorithm to consider more complex types of price adjustments. This process involves

$$( \begin{matrix}\vert \hat{B} \vert \\ k\end{matrix} ) \times ( {3}^{k} - 1 )$$

calls to \hat{P} at each step. With two products and k=2, Table 1 below illustrates all of the gradients this algorithm would test during each step. Each group of three cells in the table, enclosed in a brackets, represents a gradient, and an arrow indicates the direction of the corresponding bundle's (indicated by the column header) price movement. A cell with no arrow indicates no movement in the corresponding bundle's price. Even with k=2, this algorithm (other than the exhaustive one) may achieve optimal expected revenue.

TABLE 1

| a | b | {a, b} | a | b | {a, b} | a | b | {a, b} | a | b | {a, b} | a | b | {a, b} |
|---|---|---|---|---|---|---|---|---|---|---|---|---|---|---|
| [symbol] ↑ | | [symbol] | [symbol] ↓ | | [symbol] | [symbol] ↑ | ↑ | [symbol] | [symbol] ↑ | | ↑ [symbol] | [symbol] | ↑ | ↑ [symbol] |
| [symbol] | ↑ | [symbol] | [symbol] | ↓ | [symbol] | [symbol] ↑ | ↓ | [symbol] | [symbol] ↑ | | ↓ [symbol] | [symbol] | ↑ | ↓ [symbol] |
| [symbol] | | ↑ [symbol] | [symbol] | | ↓ [symbol] | [symbol] ↓ | ↓ | [symbol] | [symbol] ↓ | | ↓ [symbol] | [symbol] | ↓ | ↓ [symbol] |

New purchase data can be integrated into the model fitting in an online process that continually refines prices and bundle discounts. For example, an existing customer valuation model may be accessed. The customer valuation model may specify initial purchase preferences of items. The initial purchase preference may specify a probability that a customer will purchase an item at an initial price. Updated historical purchase data that is indicative of updated prices at which each of the items were purchased may be accessed. For each item specified in the updated historical purchase data, the customer valuation model may be updated to fit the updated historical purchase data. Based on the updated customer valuation model, a priceable bundle may be identified. The priceable bundle may include at least two of the items specified in the updated historical purchase data. The bundles and prices may be continually refined at periodic intervals, at predefined intervals, at requested time intervals, or a combination. For example, the customer valuation model may be updated upon detection of a triggering event, such as detection of a specified amount of purchases of items in the priceable bundle, detection of a specified amount of purchases of items in the priceable bundle in a category.

Embodiments can be implemented in digital electronic circuitry, or in computer hardware, firmware, software, or in combinations thereof. An apparatus can be implemented in a computer program product tangibly embodied or stored in a machine-readable storage device for execution by a programmable processor; and method actions can be performed by a programmable processor executing a program of instructions to perform functions by operating on input data and generating output. The embodiments described herein, and other embodiments of the invention, can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Computer readable media for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry. Any of the foregoing can be supplemented by, or incorporated in, ASICs (application-specific integrated circuits).

To provide for interaction with a user, embodiments can be implemented on a computer having a display device, e.g., a LCD (liquid crystal display) monitor, for displaying data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of embodiments, or any combination of such back end, middleware, or front end components. The components of the system can be interconnected by any form or medium of digital data communication, e.g., a communication network. Examples of communication networks include a local area network (LAN) and a wide area network (WAN), e.g., the Internet.

The system and method or parts thereof may use the “World Wide Web” (Web or WWW), which is that collection of servers on the Internet that utilize the Hypertext Transfer Protocol (HTTP). HTTP is a known application protocol that provides users access to resources, which may be data in different formats such as text, graphics, images, sound, video, Hypertext Markup Language (HTML), as well as programs. Upon specification of a link by the user, the client computer makes a TCP/IP request to a Web server and receives data, which may be another Web page that is formatted according to HTML. Users can also access other pages on the same or other servers by following instructions on the screen, entering certain data, or clicking on selected icons. It should also be noted that any type of selection device known to those skilled in the art, such as check boxes, drop-down boxes, and the like, may be used for embodiments using web pages to allow a user to select options for a given component. Servers run on a variety of platforms, including UNIX machines, although other platforms, such as Windows 2000/2003, Windows NT, Windows 7, Windows 8, Sun, Linux, and Macintosh may also be used. Computer users can view data available on servers or networks on the Web through the use of browsing software, such as Firefox, Netscape Navigator, Microsoft Internet Explorer, or Mosaic browsers. The computing system can include clients and servers. A client and server are generally remote from each other and typically interact through a communication network. The relationship of client and server arises by virtue of computer programs running on the respective computers and having a client-server relationship to each other.

Other embodiments are within the scope and spirit of the description claims. Additionally, due to the nature of software, functions described above can be implemented using software, hardware, firmware, hardwiring, or combinations of any of these. Features implementing functions may also be physically located at various positions, including being distributed such that portions of functions are implemented at different physical locations. The use of the term “a” herein and throughout the application is not used in a limiting manner and therefore is not meant to exclude a multiple meaning or a “one or more” meaning for the term “a.” Additionally, to the extent priority is claimed to a provisional patent application, it should be understood that the provisional patent application is not limiting but includes examples of how the techniques described herein may be implemented.

A number of exemplary embodiments of the invention have been described. Nevertheless, it will be understood by one of ordinary skill in the art that various modifications may be made without departing from the spirit and scope of the invention.

What is claimed is:

1. A computer-implemented method, comprising:
accessing historical purchase data that is indicative of items that have been purchased and prices at which each of the items are purchased;
for each of the items specified in the historical purchase data, fitting a customer valuation model to a portion of the historical purchase data that pertains to the item, with the customer valuation model specifying purchase preferences, and with a purchase preference specifying a probability a customer will purchase a specific item at a specific price;
based on fitted customer valuation models for the items in the historical purchase data, identifying a priceable bundle, with the priceable bundle including at least two of the items specified in the historical purchase data; and
applying updated prices to one or more of (i) the priceable bundle, and (ii) the items included in the priceable bundle.

2. The computer-implemented method of claim 1, wherein the updated prices optimize a value or cause the value to exceed a threshold level, with the value comprising one or more of:
a profit of a seller providing a bundle;
an amount of sales for the bundle;
an amount of revenue for the bundle;
a customer's surplus for the bundle, wherein the customer's surplus corresponds to a valuation of the bundle minus a price paid for the bundle by the customer; and
an amount of efficiency for the bundle, wherein the efficiency corresponds to the customer's surplus combined with the profit of the seller.

3. The computer-implemented method of claim 1, wherein the customer valuation model comprises a plurality of parameters, and wherein at least one of the parameters comprises a mean valuation of the specific item, a variance for a valuation of the specific item, and covariances between valuations for specific items.

4. The computer-implemented method of claim 1, further comprising:
determining a valuation of the priceable bundle by combining fitted customer valuation models of the items included in the priceable bundle.

5. The computer-implemented method of claim 1, wherein fitting the customer valuation model comprises:
generating a graph the includes one or more edges and a plurality of nodes, where each node of the plurality of nodes is associated with an item specified in the historical purchase data, and each edge of the one or more edges is associated with a variable representing a bonus or a penalty for a bundle including items associated with nodes connected by the edge;
performing a tree search of the graph over variances and covariances associated with bundles included in the graph;
performing a pivot-based search at each leaf node of the plurality of nodes over mean valuations associated with the bundles included in the graph; and
selecting a mean valuation, a variance, and a covariance that correspond to the historical purchase data.

6. The computer-implemented method of claim 1, wherein identifying the priceable bundle comprises:
identifying, based on application of a pricing algorithm, the priceable bundle.

7. The computer-implemented method of claim 6, wherein the pricing algorithm comprises one or more of an exhaustive pricing algorithm, a hill-climbing pricing algorithm, a gradient-ascent pricing algorithm, and a pivot-based pricing algorithm.

8. A computer-implemented method, comprising:
accessing historical purchase data that is indicative of items of a bundle that have been purchased and prices at which each of the items are purchased;
determining mean values and variance values for valuations of the items and covariance values between valuations of the items;
generating, by one or more processing devices, a graph the includes one or more edges and a plurality of nodes, where each node of the plurality of nodes is associated with an item, and each edge of the one or more edges is associated with a variable representing a bonus or a penalty for a set including items associated with nodes connected by the edge;
performing a tree search of the graph over variances and covariances associated with sets included in the graph;
performing a pivot-based search at each leaf node of the plurality of nodes over means associated with the sets included in the graph;
selecting one or more mean values, one or more variance values, and one or more covariance values that correspond to the historical purchase data; and
fitting, to the historical purchase data, a customer valuation model for one or more of (i) the bundle, and (ii) items in the bundle, with the customer valuation model being in accordance with the selected one or more mean values, the one or more variance values, and the one or more covariance values.

9. A computer-implemented method, comprising:
accessing a customer valuation model for purchase preferences of a plurality of items, and with a purchase preference specifying a probability a customer will purchase a specific item at a specific price;
based on the customer valuation model for the plurality of items, identifying a one or more of a priceable bundle and prices for items in the priceable bundle, with the priceable bundle including at least two of the items in the plurality; and
applying updated prices to one or more of (i) the priceable bundle, and (ii) the items included in the priceable bundle.

10. A computer-implemented method, comprising:
accessing a customer valuation model, with the customer valuation model specifying initial purchase preferences of items, and with an initial purchase preference specifying a probability a customer will purchase an item at an initial price;
accessing updated historical purchase data that is indicative of updated prices at which each of the items are purchased;
for each of the items specified in the updated historical purchase data, updating the customer valuation model to fit the updated historical purchase data; and
based on the updated customer valuation model, identifying a priceable bundle, with the priceable bundle including at least two of the items specified in the updated historical purchase data.

11. The computer-implemented method of claim 10, further comprising repeating the actions of claim 10 at one or more of periodic time intervals, predefined time intervals and requested time intervals.

12. The computer-implemented method of claim 10, further comprising repeating the actions of claim 10 upon detection of a triggering event.

13. The computer-implemented method of claim 12, wherein the triggering event comprises one or more of (i) a specified amount of purchases of one or more items in the priceable bundle having occurred, and (ii) a specified amount of purchases of one or more items in the priceable bundle having occurred in a category.

14. A system, comprising:
one or more processing devices; and
one or more computer-readable media storing instructions that are executable by the one or more processing devices to perform operations comprising:
accessing historical purchase data that is indicative of items that have been purchased and prices at which each of the items are purchased;
for each of the items specified in the historical purchase data, fitting a customer valuation model to a portion of the historical purchase data that pertains to the item, with the customer valuation model specifying purchase preferences, and with a purchase preference specifying a probability a customer will purchase a specific item at a specific price;
based on fitted customer valuation models for the items in the historical purchase data, identifying a priceable bundle, with the priceable bundle including at least two of the items specified in the historical purchase data; and
applying updated prices to one or more of (i) the priceable bundle, and (ii) the items included in the priceable bundle.

15. The system of claim 14, wherein the updated prices optimize a value or cause the value to exceed a threshold level, with the value comprising one or more of:
a profit of a seller providing a bundle;
an amount of sales for the bundle;
an amount of revenue for the bundle;
a customer's surplus for the bundle, wherein the customer's surplus corresponds to a valuation of the bundle minus a price paid for the bundle by the customer; and
an amount of efficiency for the bundle, wherein the efficiency corresponds to the customer's surplus combined with the profit of the seller.

16. The system of claim 14, wherein the customer valuation model comprises a plurality of parameters, and wherein at least one of the parameters comprises a mean valuation of the specific item, a variance for a valuation of the specific item, and covariances between valuations for specific items.

17. The system of claim 14, wherein the operations further comprise:
determining a valuation of the priceable bundle by combining fitted customer valuation models of the items included in the priceable bundle.

18. The system of claim 14, wherein fitting the customer valuation model comprises:
generating a graph the includes one or more edges and a plurality of nodes, where each node of the plurality of nodes is associated with an item specified in the historical purchase data, and each edge of the one or more edges is associated with a variable representing a bonus or a penalty for a bundle including items associated with nodes connected by the edge;
performing a tree search of the graph over variances and covariances associated with bundles included in the graph;
performing a pivot-based search at each leaf node of the plurality of nodes over mean valuations associated with the bundles included in the graph; and
selecting a mean valuation, a variance, and a covariance that correspond to the historical purchase data.

19. The system of claim 14, wherein identifying the priceable bundle comprises:
identifying, based on application of a pricing algorithm, the priceable bundle.

20. The system of claim 19, wherein the pricing algorithm comprises one or more of an exhaustive pricing algorithm, a hill-climbing pricing algorithm, a gradient-ascent pricing algorithm, and a pivot-based pricing algorithm.

21. A system, comprising:
one or more processing devices; and
one or more computer-readable media storing instructions that are executable by the one or more processing devices to perform operations comprising:
accessing historical purchase data that is indicative of items of a bundle that have been purchased and prices at which each of the items are purchased;
determining mean values and variance values for valuations of the items and covariance values between valuations of the items;
generating, by one or more processing devices, a graph the includes one or more edges and a plurality of nodes, where each node of the plurality of nodes is associated with an item, and each edge of the one or more edges is associated with a variable representing a bonus or a penalty for a set including items associated with nodes connected by the edge;
performing a tree search of the graph over variances and covariances associated with sets included in the graph;
performing a pivot-based search at each leaf node of the plurality of nodes over means associated with the sets included in the graph;
selecting one or more mean values, one or more variance values, and one or more covariance values that correspond to the historical purchase data; and
fitting, to the historical purchase data, a customer valuation model for one or more of (i) the bundle, and (ii) items in the bundle, with the customer valuation model being in accordance with the selected one or more mean values, the one or more variance values, and the one or more covariance values.

22. A system, comprising:
one or more processing devices; and
one or more computer-readable media storing instructions that are executable by the one or more processing devices to perform operations comprising:
accessing a customer valuation model for purchase preferences of a plurality of items, and with a purchase preference specifying a probability a customer will purchase a specific item at a specific price;
based on the customer valuation model for the plurality of items, identifying a one or more of a priceable bundle and prices for items in the priceable bundle, with the priceable bundle including at least two of the items in the plurality; and
applying updated prices to one or more of (i) the priceable bundle, and (ii) the items included in the priceable bundle.

23. A system, comprising:
one or more processing devices; and
one or more computer-readable media storing instructions that are executable by the one or more processing devices to perform operations comprising:
accessing a customer valuation model, with the customer valuation model specifying initial purchase preferences of items, and with an initial purchase preference specifying a probability a customer will purchase an item at an initial price;
accessing updated historical purchase data that is indicative of updated prices at which each of the items are purchased;
for each of the items specified in the updated historical purchase data, updating the customer valuation model to fit the updated historical purchase data; and
based on the updated customer valuation model, identifying a priceable bundle, with the priceable bundle including at least two of the items specified in the updated historical purchase data.

24. The system of claim 23, further comprising repeating the operations of claim 23 at one or more of periodic time intervals, predefined time intervals and requested time intervals.

25. The system of claim 23, further comprising repeating the operations of claim 23 upon detection of a triggering event.

26. The system of claim 25, wherein the triggering event comprises one or more of (i) a specified amount of purchases of one or more items in the priceable bundle having occurred, and (ii) a specified amount of purchases of one or more items in the priceable bundle having occurred in a category.

27. One or more computer-readable media storing instructions that are executable by one or more processing devices to perform operations comprising:
accessing historical purchase data that is indicative of items that have been purchased and prices at which each of the items are purchased;
for each of the items specified in the historical purchase data, fitting a customer valuation model to a portion of the historical purchase data that pertains to the item, with the customer valuation model specifying purchase preferences, and with a purchase preference specifying a probability a customer will purchase a specific item at a specific price;
based on fitted customer valuation models for the items in the historical purchase data, identifying a priceable bundle, with the priceable bundle including at least two of the items specified in the historical purchase data; and
applying updated prices to one or more of (i) the priceable bundle, and (ii) the items included in the priceable bundle.

28. The one or more computer-readable media of claim 27, wherein the updated prices optimize a value or cause the value to exceed a threshold level, with the value comprising one or more of:
a profit of a seller providing a bundle;
an amount of sales for the bundle;
an amount of revenue for the bundle;
a customer's surplus for the bundle, wherein the customer's surplus corresponds to a valuation of the bundle minus a price paid for the bundle by the customer; and
an amount of efficiency for the bundle, wherein the efficiency corresponds to the customer's surplus combined with the profit of the seller.

29. The one or more computer-readable media of claim 27, wherein the customer valuation model comprises a plurality of parameters, and wherein at least one of the parameters comprises a mean valuation of the specific item, a variance for a valuation of the specific item, and covariances between valuations for specific items.

30. The one or more computer-readable media of claim 27, wherein the operations further comprise:
determining a valuation of the priceable bundle by combining fitted customer valuation models of the items included in the priceable bundle.

31. The one or more computer-readable media of claim 27, wherein fitting the customer valuation model comprises:
generating a graph the includes one or more edges and a plurality of nodes, where each node of the plurality of nodes is associated with an item specified in the historical purchase data, and each edge of the one or more edges is associated with a variable representing a bonus or a penalty for a bundle including items associated with nodes connected by the edge;
performing a tree search of the graph over variances and covariances associated with bundles included in the graph;
performing a pivot-based search at each leaf node of the plurality of nodes over mean valuations associated with the bundles included in the graph; and
selecting a mean valuation, a variance, and a covariance that correspond to the historical purchase data.

32. The one or more computer-readable media of claim 27, wherein identifying the priceable bundle comprises:
identifying, based on application of a pricing algorithm, the priceable bundle.

33. The one or more computer-readable media of claim 33, wherein the pricing algorithm comprises one or more of an exhaustive pricing algorithm, a hill-climbing pricing algorithm, a gradient-ascent pricing algorithm, and a pivot-based pricing algorithm.

34. One or more computer-readable media storing instructions that are executable by one or more processing devices to perform operations comprising:
accessing historical purchase data that is indicative of items of a bundle that have been purchased and prices at which each of the items are purchased;
determining mean values and variance values for valuations of the items and covariance values between valuations of the items;
generating, by one or more processing devices, a graph the includes one or more edges and a plurality of nodes, where each node of the plurality of nodes is associated with an item, and each edge of the one or more edges is associated with a variable representing a bonus or a penalty for a set including items associated with nodes connected by the edge;
performing a tree search of the graph over variances and covariances associated with sets included in the graph;
performing a pivot-based search at each leaf node of the plurality of nodes over means associated with the sets included in the graph;
selecting one or more mean values, one or more variance values, and one or more covariance values that correspond to the historical purchase data; and
fitting, to the historical purchase data, a customer valuation model for one or more of (i) the bundle, and (ii) items in the bundle, with the customer valuation model being in accordance with the selected one or more mean values, the one or more variance values, and the one or more covariance values.

35. One or more computer-readable media storing instructions that are executable by one or more processing devices to perform operations comprising:
accessing a customer valuation model for purchase preferences of a plurality of items, and with a purchase preference specifying a probability a customer will purchase a specific item at a specific price;
based on the customer valuation model for the plurality of items, identifying a one or more of a priceable bundle and prices for items in the priceable bundle, with the priceable bundle including at least two of the items in the plurality; and
applying updated prices to one or more of (i) the priceable bundle, and (ii) the items included in the priceable bundle.

36. One or more computer-readable media storing instructions that are executable by one or more processing devices to perform operations comprising:
accessing a customer valuation model, with the customer valuation model specifying initial purchase preferences of items, and with an initial purchase preference specifying a probability a customer will purchase an item at an initial price;
accessing updated historical purchase data that is indicative of updated prices at which each of the items are purchased;
for each of the items specified in the updated historical purchase data, updating the customer valuation model to fit the updated historical purchase data; and
based on the updated customer valuation model, identifying a priceable bundle, with the priceable bundle including at least two of the items specified in the updated historical purchase data.

37. The one or more computer-readable media of claim 36, further comprising repeating the actions of claim 10 at one or more of periodic time intervals, predefined time intervals and requested time intervals.

38. The one or more computer-readable media of claim 36, further comprising repeating the actions of claim 10 upon detection of a triggering event.

39. The one or more computer-readable media of claim 38, wherein the triggering event comprises one or more of (i) a specified amount of purchases of one or more items in the priceable bundle having occurred, and (ii) a specified amount of purchases of one or more items in the priceable bundle having occurred in a category.
